(19) United States
(12) Patent Application Publication
(10) Pub. No.: US 2004/0073410 A1
(43) Pub. Date: Apr. 15, 2004

(54) Computerized system and method of collaborative structural frame development

(75) Inventors: John Maly, Littleton, CO (US); Robert Baynit, Englewood, CO (US); Michael Tooley, Monument, CO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Optiframe Software, LLC

(21) Appl. No.: 10/271,122

(22) Filed: Oct. 15, 2002

(51) Int. Cl. G06F 17/50

(52) U.S. Cl. 703/1

(57) ABSTRACT

Computerized methods and systems for modeling a structural frame of a building. One or more client computers and a central server are coupled to a data communications network. The central server receives a plurality of input parameters representative of design characteristics of the building frame from users via the client computers. The central server consolidates the input parameters according to a defined hierarchy among the users to resolve conflicts between two or more of the input parameters. The central server further generates a building frame model based on the consolidated input parameters to optimize construction of an actual building frame according to the model. The model assigns load values to load bearing members of the building frame based on connections between the members.

### TECHNICAL FIELD

The present invention relates generally to computerized systems and methods for analyzing and designing a structural frame of a building and, particularly, to a whole-house design software that comprehensively and collaboratively performs complete analysis of the structure, systems, members, and building materials to develop an optimized solution for constructing the building frame.

### BACKGROUND OF THE INVENTION

Recently, more than one million new homes are built each year in North America. Within this residential building market, the cost of materials used in constructing the structural frames of the homes exceeds $20 billion annually. Notwithstanding the large market, builders, lumber dealers, and component suppliers lack an integrated software solution that defines the optimized structural solutions and complete material list for the structural frame (e.g., roof, walls, floors, accessories, connectors, etc.). Large consolidated lumberyard/component fabricators often control the integration of structural materials in residential projects without the benefit of understanding the interaction among the various components of the frame.

For example, a building designer typically decides on characteristics of the building such as the walls, elevations, dimensions, and the like. An engineer assesses the loads present on the many members of the frame and reviews the frame system methodologies being employed. A framer determines spacing, layout preferences, and the like. Unfortunately, the participants in the conventional design process act independently of each other and the builder is left to integrate their input. The builder then delivers drawings to a large component fabricator or lumber dealer for determining the necessary lumber and components needed to construct the frame. As a result of this disconnected design process, incorrect assumptions are often made about the location and amount of loads on the various load bearing members of the frame. Problems occur because, for example, a wall is not properly positioned to adequately support a truss. This can result in frame defects such as cracked walls and the like. On the other hand, the need for built-in redundancies and over-engineering to prevent such problems produces undesirable inefficiencies and increased materials expense.

A number of software applications, often inaptly referred to as whole house solutions, are built on Computer Aided Drawing (CAD) drawing tool technology. These software programs are focused primarily on visualization and material list accumulation. Material selection is merely based on look-up table technology rather than a load-based structural analysis.

For these reasons, improved systems and methods for the building industry are desired to address one or more of these and other disadvantages. Such desired improvements include computerized systems and methods that encompass the complete design and optimization of the structural frame, provide tight integration of all the materials contributing to the structural frame of the building, and reduce inefficiencies and errors in the design process.

### SUMMARY OF THE INVENTION

The invention meets the above needs and overcomes one or more deficiencies in the prior art by providing automated building frame analysis and design. Advantageously, the invention provides builders, design professionals, material suppliers, and component manufacturers, particularly those involved in residential home building, with a timely and cost-effective software system to solve whole-house design, construction, and material optimization challenges. The present invention allows multiple users (e.g., participants from the residential building team) to collaboratively specify and control various design parameters in the optimization of the structural frame. The invention comprehensively and collaboratively performs complete analysis of the structure, systems, members, and building materials to develop a “best system” solution. Degrees of optimization include the selection of framing schemes or practices to minimize jobsite labor and waste, reduce the need for redundant structural materials, and maximize the efficiency of component manufacturers and material suppliers. In contrast to the prior art, computerized systems and methods according to the present invention provide credible design solutions, allow collaborative input from specifiers, builders, component fabricators, lumber dealers, and the like, as well as allow specification of both proprietary and generic products through an open interface. The software of the invention advantageously utilizes an “open architecture” to accommodate linkage to third party program modules (e.g., other wood-based products and systems, including complementary products and accessories).

In one embodiment, design and optimization scope covers the entire structural frame of the building above the foundation. This includes all materials (e.g., engineered wood products, pre-fabricated components, structural systems, conventional framing, and critical connections).

The present invention contemplates use in some fashion by the entire homebuilding team. The software can be configured as a stand-alone system or with specific input, editing, or output modules selectively deployed across the building team to maximize the collaborative optimization process. When selective deployment is used, core optimization modules reside with the suppliers of materials and services that have the unique skills, expertise, or information availability for driving the most optimized and competitive structural solution.

Moreover, the features of the present invention described herein are less laborious and easier to implement than currently available techniques as well as being economically feasible and commercially practical.

Briefly described, a computerized method embodying aspects of the invention models a structural frame of a building. The method includes identifying one or more of members of the building frame bearing at least a portion of a total load to be supported and identifying connections between the load bearing members. The method also includes assigning load values to the load bearing members of the building frame based on the identified connections and then generating a building frame model based on the assigned load values. In this manner, the method optimizes construction of an actual building frame according to the model.

In another embodiment, a computerized method models a structural frame of a building based on collaborative input from one or more users. The method begins by receiving a plurality of input parameters from the users. The input parameters are representative of design characteristics of the building frame and are received by a central server via one or more client computers operated by the users. In this embodiment, the central server and client computers are coupled to a data communication network. The method also includes defining a hierarchy among the users to resolve conflicts between two or more of the input parameters and consolidating the input parameters by the central server according to the defined hierarchy. The method continues with generating a building frame model based on the consolidated input parameters to optimize construction of an actual building frame according to the model and communicating the building frame model to one or more of the users via the client computers.

Another embodiment of the invention is directed to a computer-readable medium having computer-executable subsystem components. The subsystem components include a client view subsystem for data input and visualization regarding a structural building frame, a services subsystem for managing data flow, and a material management subsystem for managing building material inventory and design preferences of the building frame. The computer-readable medium also includes an entity component subsystem for managing activation of one or more components. In this embodiment, the components are software modules responsive to one or more input parameters representative of design characteristics of the building frame. An engineering subsystem of the invention manages structural analysis and design of the building frame and a database subsystem is provided for saving and retrieving job data relating to construction of an actual building frame.

In yet another form, a system for modeling a structural frame of a building embodies aspects of the invention. The system includes one or more client computers and a central server coupled to a data communications network. The central server receives a plurality of input parameters from the users via one or more of the client computers. The input parameters are representative of design characteristics of the building frame. The central server consolidates the input parameters according to a defined hierarchy among the users to resolve conflicts between two or more of the input parameters and a database associated with the central server stores job information. The central server generates a building frame model based on the consolidated input parameters and the stored job information to optimize construction of an actual building frame according to the model.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary block diagram illustrating a network environment according to the invention.

FIG. 2 is another exemplary block diagram illustrating the network environment of FIG. 1.

FIGS. 3-5 are exemplary flow charts illustrating operation of structural frame software system according to the invention.

FIG. 6 is an exemplary block diagram illustrating a data structure including a plurality of software component subsystems according to the invention.

FIGS. 7-9 are exemplary architectural drawings illustrating aspects of the structural frame software system.

Corresponding reference characters indicate corresponding parts throughout the drawings.

### DETAILED DESCRIPTION OF THE INVENTION

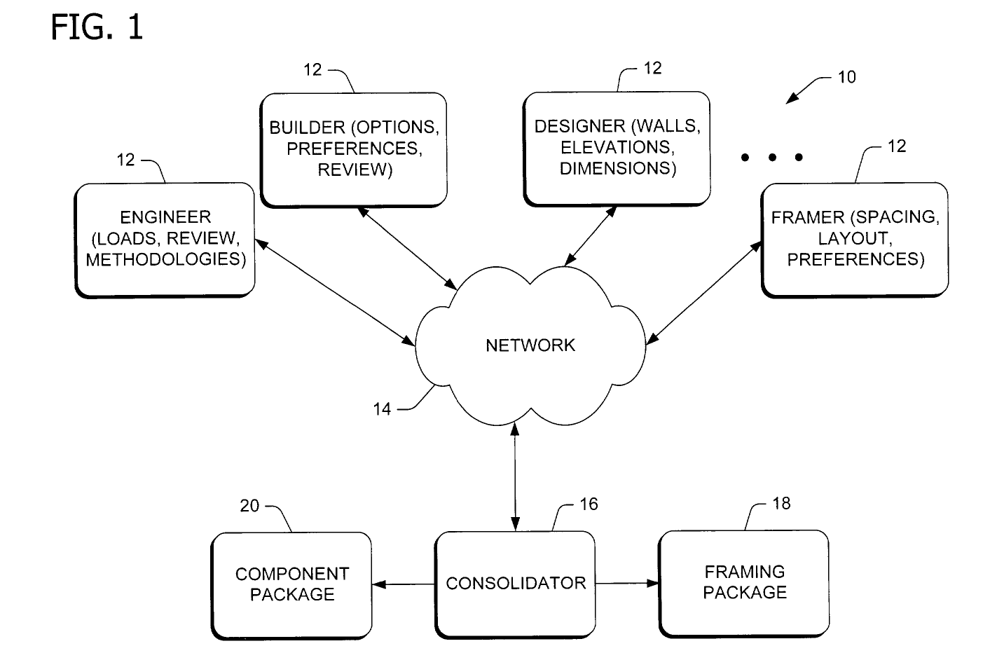

Referring now to the drawings, FIG. 1 illustrates an exemplary network environment in which system 10 according to the present invention is utilized. The present invention allows multiple users (e.g., participants from a residential building team) to collaboratively specify and control various design parameters in the optimization of the structural frame of a building. The system 10 employs “whole-house” design for comprehensively and collaboratively performing a complete analysis of the structure, including its systems, members, and building materials. In this manner, system 10 develops a “best system” solution. The primary role of the software according to the invention is to design, analyze, and integrate all of the materials and components in the structural frame of a home from the foundation up.

The system 10 preferably implements software that has an “open architecture” to accommodate linking to third party program modules or data transfer between the system and third party programs. For example, the software allows collaborative inputs from specifiers, builders, component fabricators, and lumber dealers, as well as specification of both proprietary and generic products through an open interface. Users can create a building model; generate a baseline cost estimate; design, manufacture, and supply trusses from the model; design, manufacture, and supply wall panels; design and supply engineered wood products (EWP); or the like. Material specification, design, and optimization are based on generic industry and code-accepted methodologies for wood frame construction. In addition, degrees of optimization include the selection of framing schemes or practices to minimize jobsite labor and waste, reduce the need for redundant structural materials, and maximize the efficiency of component manufacturers and material suppliers.

As shown in FIG. 1, one or more client computers 12 are coupled to a data communication network 14. In this example, the network 14 is the Internet (or the World Wide Web). However, the teachings of the present invention can be applied to any data communication network. A central server 16, referred to in FIG. 1 as a consolidator, is also coupled to network 14. In turn, the client computers 12 can access the central server 16 via network 14. A web server capable of interacting with web browsers and other web servers may embody central server 16. In this example, data is communicated between client computers 12 and central server 16 using the hypertext transfer protocol (HTTP), a protocol commonly used on the Internet to exchange information.

In FIG. 1, client computers 12 further execute a plurality of modules to allow inputs from different groups of users. For example, the present invention includes a designer/spatial modeling input module, a specifier/engineer preferences input module, a framer/site erection preferences input module, and a builder information input module. Although not specifically illustrated, it is to be understood that additional modules of the type described herein may be implemented.

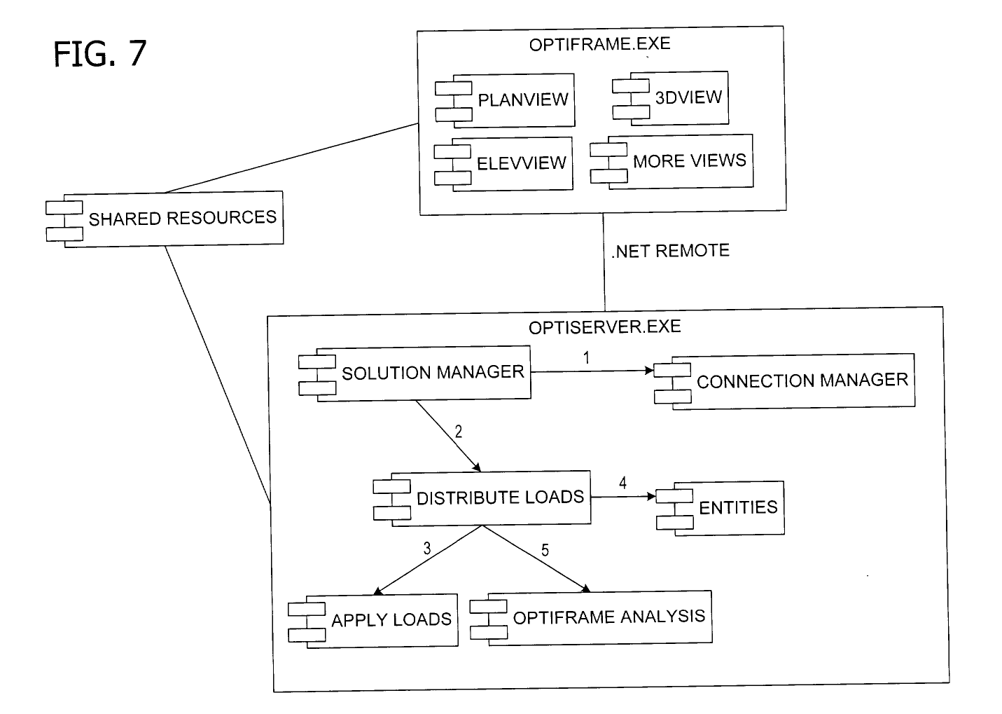

The client computers 12 and central server 16, executing the modules of the invention, enable collaborative input via data communication network 14. The invention allows for either single-user input or multiple-user collaborated input on a single network 14. For clarity, multiple-user input is preferably confined to features or functionality that can be defined as independent from input generated by another user. Examples of multiple-user input include specific design preferences, independent input, or review status to various levels of a structure. In implementation, multiple users use an executable program designated OptiFrame.exe to provide inputs to OptiServer.exe via .Net remote services (see exemplary architecture diagrams FIGS. 7-9). A single “master” user then controls analysis and optimization to facilitate the collaborative input from multiple users.

In one embodiment, the system 10 handles essentially every aspect of designing an optimized structural frame for a building. The invention implements software, either in multiple modules or in an integrated, single module, to cover residential structural applications and systems from the foundation to the roof of the structure. The structural applications include at least the roof, walls, floors, connections, and structural solutions required by openings in the structure such as windows, doors, stairways, and skylights. System 10 allows a user to develop both structural and component level loads from gravity, wind, and seismic forces as defined in, for example, the International Building Code, for all members and components of the structural frame. A user-selectable option permits the user to automatically detect and generate primary members (i.e., structural members or components supporting other members or components) for internally generated loads from upper levels and for user defined openings.

The user can also select products by verifying if a predetermined solution meets or exceeds all selected design criteria and looking across a range of products to determine a list of possible solutions. System 10 is designed to seek a “best system” solution within a range of verified and acceptable design solutions that generate the lowest costs. Software routines determine the lowest costs from a matrix of possible best system criterion but permit the user to manually select or override the automatic selections for products that are specified independently of the program design solutions.

Further, system 10 allows for selection and specification of materials that are not specifically designed but are important to the complete structural frame and/or the accumulation of materials for the generation of a cost for the complete structure. Non-structural materials include, for example, construction materials, opening closures, covering materials, and insulation materials. In addition to the design and selection of primary members and secondary members (i.e., members not carrying other members), system 10 can design and automatically select accessory materials from a range of products using rules-based or load-based logic. Accessory materials include bearing location accessories (e.g., blocking, decking edge blocking, and ladder panels) and non-bearing locations accessories (e.g., bridging and bracing).

The system 10 further has the ability to analyze and design mechanical connectors that tie various products, systems, or subsystems together to complete the structural frame. The capabilities of this module include multiple manufacturer capability; designation for specific application and load requirements; consideration for multiple applications and conditions; and generic connector specifications.

Referring further to FIG. 1, central server 16 acts as the consolidator to integrate the various inputs from one or more of the engineer, builder, designer, and/or framer modules of client computers 12 and then output an optimized framing package.18 and an optimized component package 20 for use in constructing the actual structural frame for the building. In this embodiment, the framing and component packages 18, 20 constitute a building frame model generated by central server 16.

According to the invention, central server 16 consolidates the input parameters according to a defined hierarchy among the users to resolve conflicts between two or more of the input parameters. Typically this conflict heiarchy resolution is based upon levels of “seniority” assigned and associated with the various collaborators for a specific job. A database associated with the central server stores all of the pertinent and relevant job information and customer information in files. The central server generates a building frame model based on the consolidated input parameters and the stored job information to optimize construction of an actual building frame according to the model.

Referring further to system 10, the software of the invention also generates user-defined cost analysis that determines a preliminary “estimated” cost and a more “detailed” cost of the overall structure. The “estimated” cost may be based on a generic model of the structure, in advance of designing and selecting specific product solutions. The “detailed” cost of the overall structure identifies the impact of various product or “best system” solutions that can be used at any designed level or for the entire designed structure.

The collaborative network environment of system 10 permits communicating details of the structural solution to those who put it together in the field. Server 16 generates this output immediately after the entire structural frame and system and all primary and secondary members of the frame have been analyzed, designed, and selected by the user. The output modes of this module include framer mode, building inspector mode, and specifier mode.

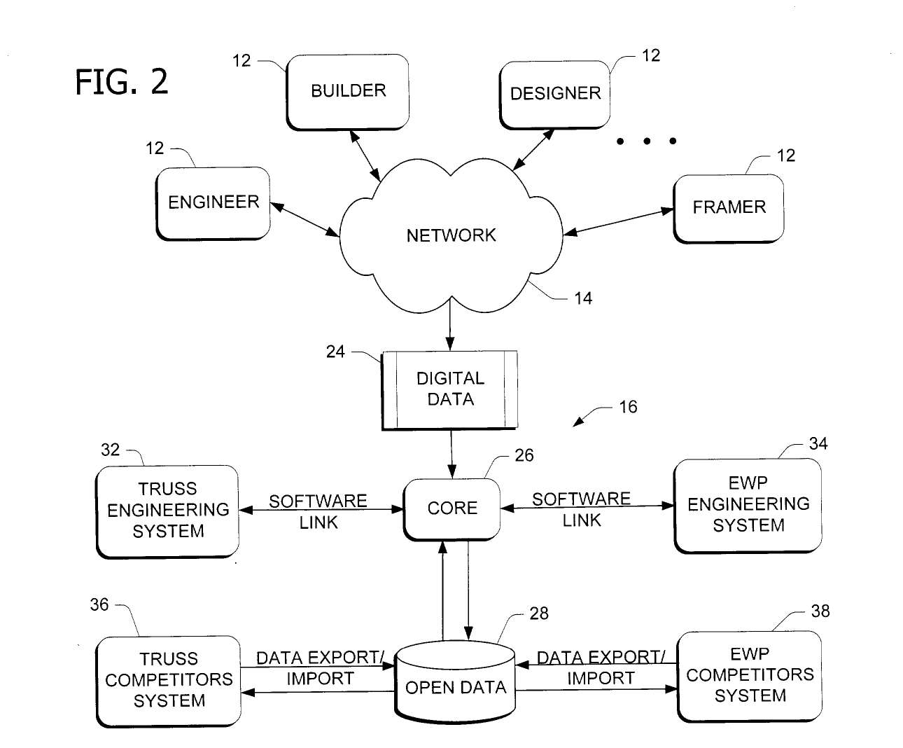

Referring now to FIG. 2, system 10 employs a component-based open software architecture that facilitates linking the software of the invention to third party modules (e.g., other wood-based products and systems, including complementary products and accessories). As described above, system 10 allows multiple users (e.g., participants from the residential building team) to collaboratively specify and control various design parameters in the optimization of the structural frame. System 10 also provides Internet-enabled input. The program input is configured according to the invention to allow single user input or to permit multiple users on a single network to collaborate on the input. Multi-user input is preferably confined to features or functionality that can be defined as independent from input generated by another user. This includes, for example, specific design preferences or independent input or review status to various levels of a structure. Moreover, a single user can control analysis and optimization to facilitate the collaborative input from multiple users.

The system 10 provides a number of data import and export capabilities for data and reports with dynamic data input and export features to allow for interconnectivity with external programs. The range of available information and capabilities includes external CAD programs, product design programs, inventory management programs, project management programs, point of sale programs, and CAD/CAM (Computer Aided Drafting/Computer Aided Machinery) applications. In one implementation, the component cookbook (see exemplary architecture diagrams FIGS. 7-9) reads design specifications of external programs and then designs extensions of existing components (referred to as Entity Families, an entity family consists of a manager, one or more entities, and one or more properties) using rules of inheritance and following the specifications previously read. After the components are designed, the user loads the components into specific directories of the present software.

In one embodiment of the invention, a computer-readable medium has computer-executable components. The components include a structure analysis and design components, families of structural and non-structural entity components (a component family consists of a manager, one or more entities, and one or more properties), and specific utility and supplemental functionality type components. The computer-readable medium further includes a component development “cookbook” providing a template for designing one or more new components. It further includes an enterprise wide data repository that can be used to store job data, materials, defaults, preferences, or any data requested by the user. For those not wishing to use the database functionality features, Microsoft®.Net persistence is available behind the scenes at the flip of a switch.

As shown in FIG. 2, the input modules are built into a number of different modules that can be linked together for a single user or split apart for collaborative users. These input modules may be deployed over the data communication network 14 for the creation and or review and editing of the input data that drives the collaborative structural solution. The resulting data files may be transmitted by e-mail or other collaborative means. Central server 16 consolidates information from the other modules into a unified job input, shown in FIG. 2 as digital data 24. In this instance, the digital data 24 represents the frame model and select preferences and structural solutions for the unified job.

FIG. 2 also illustrates a software core 26, which central server 16 executes for implementing the invention. The open, extensible component architecture provides a high performance lightweight client; powerful, reusable component design; distributed, secure .net remoting features; and a plug and play interface for connectivity and easy upgrades. Moreover, a central data repository 28 facilitates data mining/reporting capabilities.

With respect to the data repository 28, the software of the invention has a number of relational product data files that provide information critical to the analysis and design of the structural products. The product data files include, for example, partner developed property files (e.g., via truss engineering system 32 or EWP engineering system 34). In addition, the product data files include customer-developed generic product property files, and proprietary product property files (e.g., via truss competitors system 36 or EWP competitors system 38). In addition, data repository 28 preferably stores application specific data that has tremendous value to the home construction industry but are beyond the specific whole house analysis and design. Examples of industry data include software use information, product use information, design methodology information, and generic project information.

In one preferred embodiment of the invention, system 10 embodies data repository 28 with a common data repository (CDR) leveraging proven Microsoft technologies (SQL Server 2000) for persistent storage of all relevant data. This provides transactional consistency, superior data access speeds and scalability, robust reporting/logging capabilities, enhanced security, and multiple user access capabilities. In addition, the software of the present invention provides an automated database backup and optimization utility.

As described above, the interface modules executed by client computers 12 include a designer/spatial modeling input module. The input from the designer module covers the spatial modeling of the job and includes the locations and parameters that define the basic structural elements (walls, roofs, floors, openings, objects, etc) and the resulting primary and secondary component definitions. This module can interpret click points from imported and externally developed DXF and DWG CAD files and includes 3D viewing technology for visualization (includes rotation and elevation capabilities).

A specifier/engineer preferences input module establishes the base gravity and lateral load values. This module also specifies all special loads and locations, sets the component and structure performance requirements, and selects the appropriate member and system design methodology. The engineer module also determines all other “analysis and design” preferences and reviews individual components/designs.

Referring now to a framer/site erection preferences input module, the present invention permits specifying framing system parameters (e.g., stick built versus components) and framing layout drawing preferences (sheet size, presentation format, included information, etc.). The framer module also establishes component level preferences (length of panels, corner preferences, etc.) and sets material list preferences and other framing practices options.

A builder information input module permits the builder to specify product (by brand or category) and performance preferences. Through use of the software, the builder can be notified continuously of any price changes directly from its material suppliers and component fabricators. The sharing of identical data files assures the builder of accurate design and construction feasibility numbers. The software allows for collaborative input from all parties involved in a project. Any and/or all of the following can input and access the complete (or parts thereof) building design data files using system 10: component fabricator, material supplier, design center, or builder (someone on builder's staff). Because of this shared access, the builder is quickly informed of any changes in material cost or design. Conversely, the builder can change the building plans and quickly relay the information to the other parties.

In a similar manner, a component fabricator can increase production, increase the degree of structural optimization, improve automation efficiency, and decrease manufacturing errors by utilizing data file sharing. Inasmuch as all users have direct access to shared data files, the component fabricator is constantly updated regarding design changes, which increases both productivity and profitability. The data sharing capabilities of the software also benefit the lumber dealer, which can be made continually aware of any design specification or material specification changes requested or required by the designer, component fabricator, or builder. The lumber dealer can remain in essentially constant contact with the specifier (builder), which in turn communicates with the engineers, designers, and component fabricators. This assures the lumber dealer its delivery trucks are loaded with the correct material for the project.

In one embodiment of the invention, central server 16 executes a master input module to consolidate information from the other modules into a unified job input and a review module for viewing/reviewing the model, selecting preferences, and structural solutions of the unified job. The master input module also merges all data into a single master preferences and data file (see digital data 24.

The system 10 also implements a three-dimensional drafting module to provide CAD capabilities, namely, editing and viewing program output. The features of this module include CAD drawing/editing features, CAD visibility tools, CAD printing tools, and CAD specific file formats.

The software implemented by system 10 preferably distributes all externally generated (user-input) and all internally generated (program-generated) structural loads and determines what members of the frame bear on other members and provides various options for load optimization. In other words, system 10 assigns loads to the building frame and develops member connectivity so that through various rules and logic, loads can be distributed through the structure and to all of the appropriate members. System 10 preferably determines which members collect loads and how the members are connected to each other and determines a loading sequence for analyzing the structure. For example, the user can select a range of speed versus accuracy from load distribution options, which result in different levels of member design optimization. Other user-selectable options include those for manipulating user-input and program-generated loads, load locations, and reaction locations.

The following provides a brief description of manipulation options selectable by the user: load magnitude manipulation translates the magnitude of some concentrated loads and uniform loads into a different form that is more appropriate to the structural resistance system; load location manipulation allows for movement of load locations to account for the problems caused by structural elements that have width that can attract loads at locations other than the member centerline; and support reaction manipulation accounts for the problems caused by modeling the structure as if all of the supports are infinitely rigid.

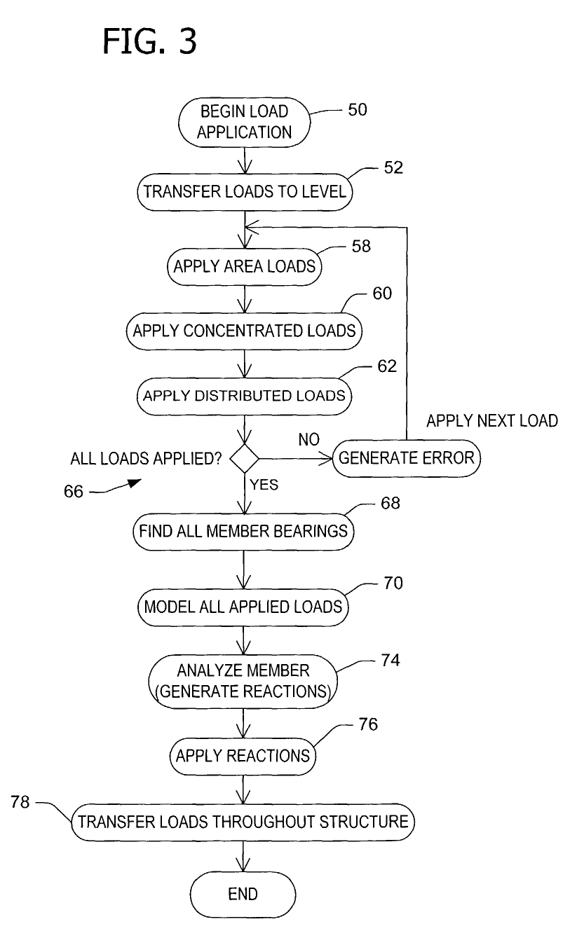

FIG. 3 is an exemplary flow diagram illustrating routines for performing a load distribution according to the invention. Beginning first at 50, the central server 16 of system 10 proceeds to transfer loads from one or more upper levels to a current level at 52. The loads are placed in appropriate categories. All loads that will be applied to a member at this point is either user input or generated from a level above the current level. Central server 16 proceeds to 58, 60, and 62 for applying the loads. At 58, central server 16 applies all area loads entered on the current level to the members that will carry them. Similarly, central server 16 applies all concentrated loads on the current level to the members that will carry them at 60. The concentrated loads include loads from above as well as any user input loads. Proceeding to 62, system 10 applies all distributed loads on the current level to the members that will carry them. The distributed loads also include loads from above in addition to any user input loads.

After all loads have been applied at 66, central server 16 continues at 68 to find bearings for each member to establish a distribution hierarchy. Central server 16 then models the loads that have been applied to the member at 70. The loads are preferably modeled in local coordinates to reflect their direct relationship to the member. Proceeding to 74, the software of system 10 analyzes the design problem to generate all reactions based on the loading that the member is carrying and the configuration of the loads. In turn, system 10 applies the reactions to the bearings at 76. Each member contains a list of bearings providing support. Reactions are distributed as loads the supporting member is carrying. Load reductions will occur at this point in the process based on the area the support is carrying. At 78, the central server 16 of system 10 transfers all loads that have been applied to members throughout the structure. The location of these members determines the location of the loads that they have transferred.

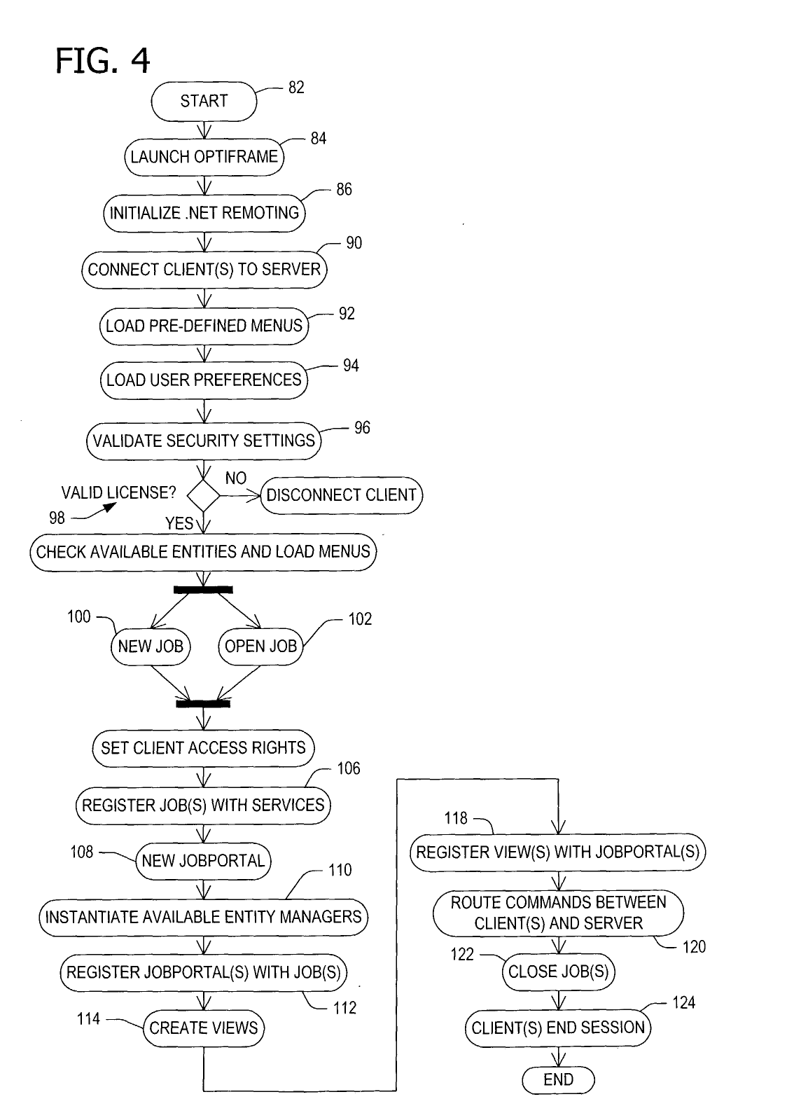

Referring now to the flow diagram of FIG. 4, the present invention provides collaborative input beginning at 82. Proceeding directly to 84, system 10 launches the application and establishes connections from the client computers 12 to the server 16. In one embodiment, the first client 12 launches the server 16 if it is not already running. System 10 initializes .Net remote in OptiServer at 86 so it will wait for client connections. At 90, any number of clients 12 can connect to server 16 via .Net remoting. System 10 loads predefined menus in client 12 (e.g., “help” or “search”) at 92. At 94, system 10 loads user preferences and the defaults into memory (e.g., data repository 28). The security settings are also loaded for license checks and component availability security checks at 96. Proceeding to 98, system 10 checks the entities for availability based on what has been shipped and licensed. Server 16 dynamically generates the menus for the entities and sends them to the clients 12 for display. The client 12 will create a new job at 100 or open an existing one at 102. If client 12 creates a new job or is the first to open an existing one, it will have full access rights. Any client 12 opening the same job after one has already been opened will have read only rights in this embodiment of the invention.

At 106, system 10 registers the job with a service manager for tracking all open jobs. A job portal at 108 permits messaging between client 12 views and server 16. System 10 launches all of the available entity managers in preparation for client input at 110. Proceeding to 112, system 10 registers the job portal with the job for tracking all open portals and then creates all of the views for a client 12 at 114. All of the views are registered with the job portal at 118 so the portal can message with them. At 120, system 10 routes client commands from the views via an iUserInput interface down through server 16 to the correct entity for execution. After each command is complete, a “job changed” message is sent at 122 to the views, which tells each of them to update their display. Then system 10 processes the next command and so on. The job closes at 124 and everything is de-registered and the client session ends.

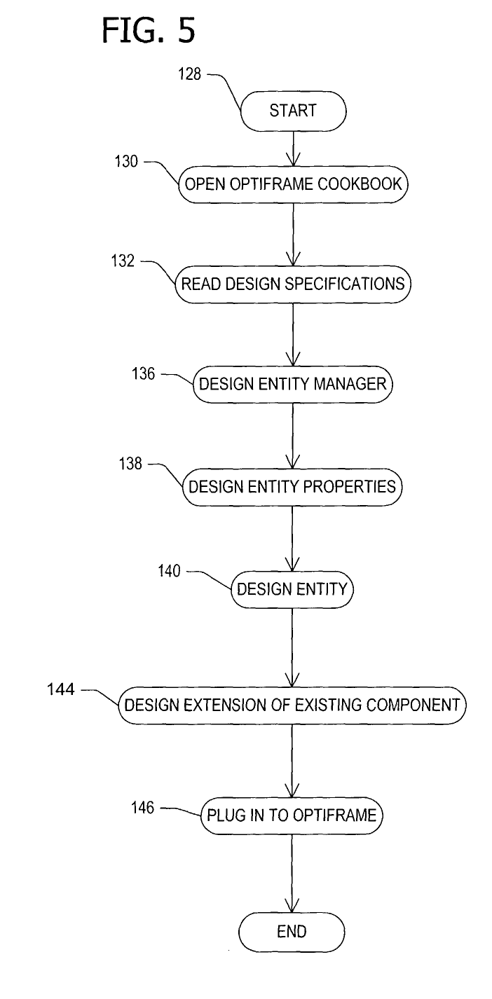

FIG. 5 is an exemplary flow diagram illustrating operation of system 10 to create a plug-and-play environment according to the invention. After starting at 128, system 10 proceeds to 130 for opening the Optiframe component cookbook, which contains all of the component design specifications, the framework, and the security and integrations specifications. System 10 then, at 132, reads and follows the included design specifications for interfaces, security, user preferences, and engineering. At 136, system 10 uses an entity manager framework to design a new entity manager component following the specification previously read. System 10 uses an entity properties framework at 138 to design a new entity properties component following the specification previously read. Continuing at 140, system 10 uses an entity framework to design a new entity component following the specification previously read. At 144, system 10 designs an extension of an existing component using the rules of inheritance and following the specifications previously read if so desired. After the components are designed, at 146, system 10 insures the new components are registered with Optiframe security by calling Optiframe, stop the OptiServer.exe and Optiframe.exe, load the components into the specified directories, and restart OptiServer.exe and Optiframe.exe.

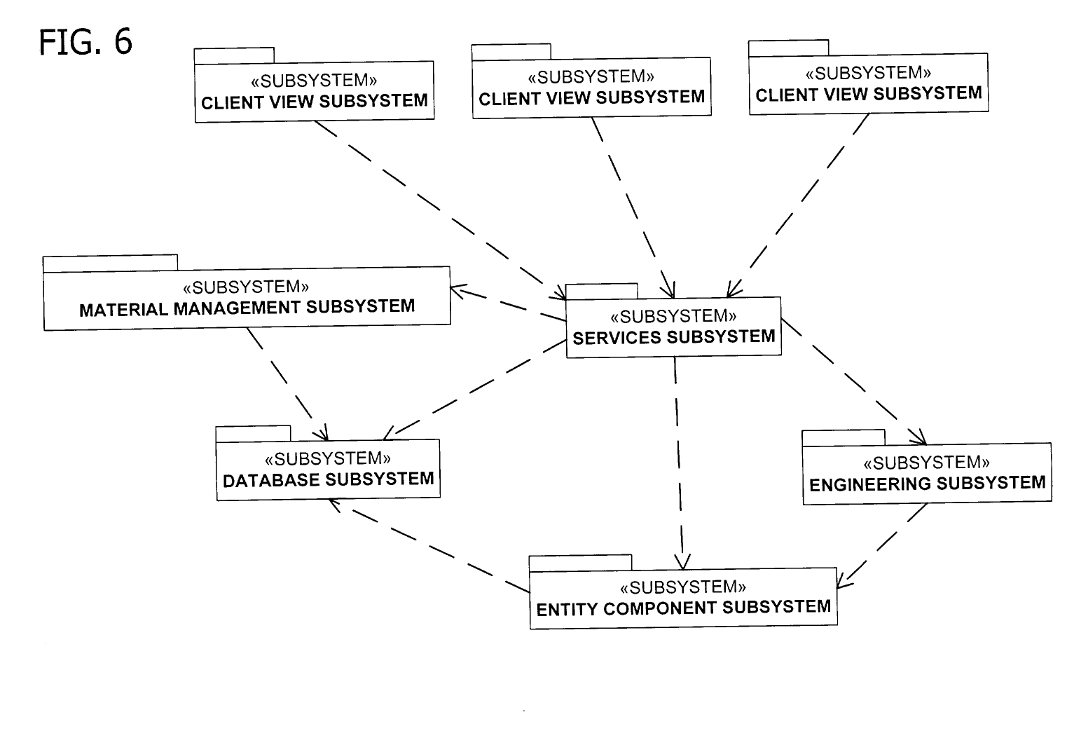

FIG. 6 is an exemplary block diagram illustrating a data structure including a plurality of software component subsystems according to the invention.

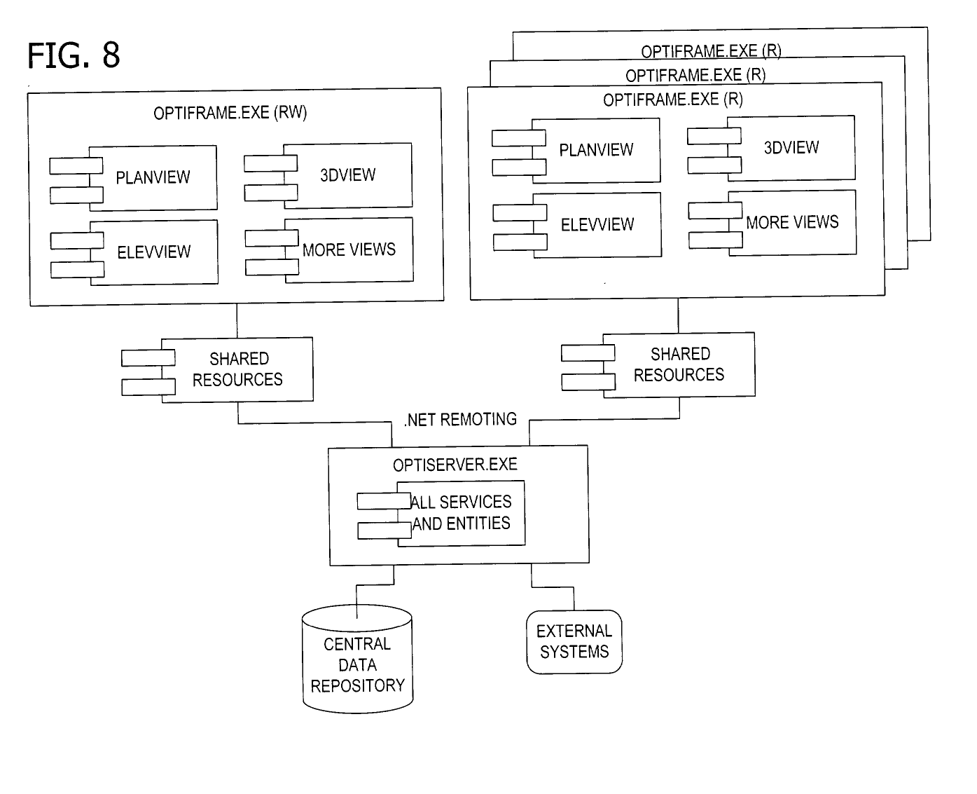

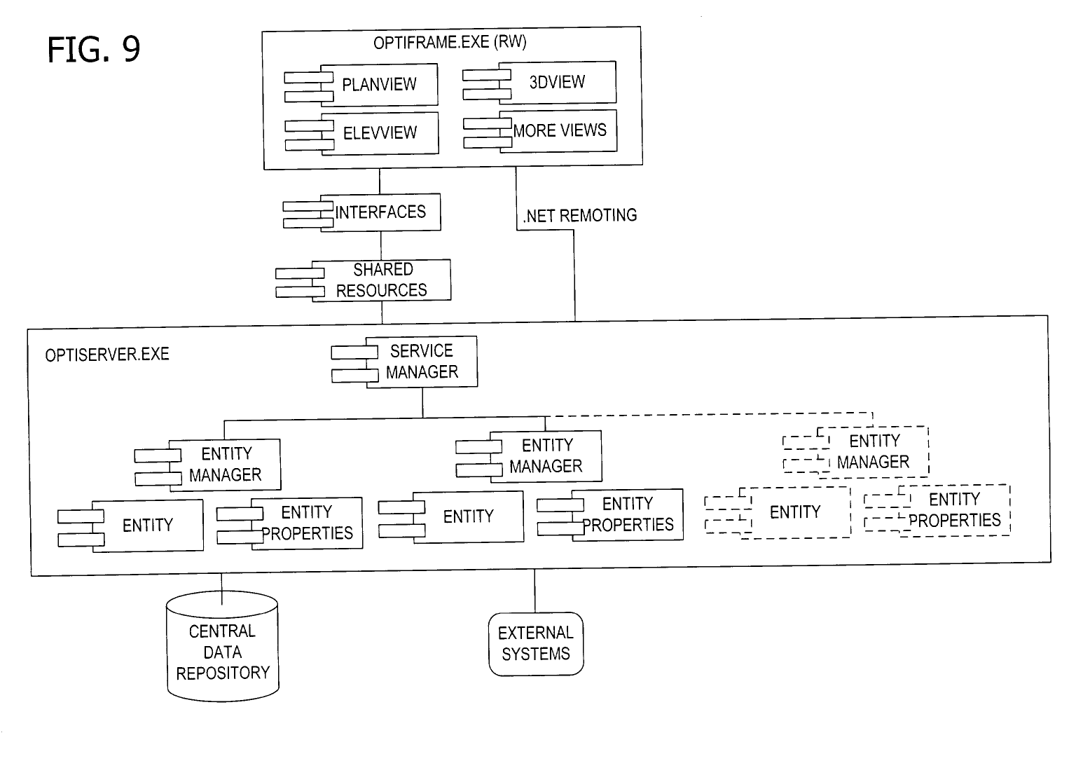

FIGS. 7-9 are exemplary architectural drawings illustrating aspects of the structural frame software system. FIG. 7 illustrates an architecture for load distribution; FIG. 8 illustrates an architecture for collaborative input; and FIG. 9 illustrates an architecture for plug-and-play components.

APPENDIX A describes various participants and users of system 10, or stakeholders in the project. APPENDIX A further provides examples of the users of system 10. APPENDIX B describes product features of an exemplary software program embodying aspects of the invention. In particular, APPENDIX B provides information on product and structural system applications; building code and industry-based methodologies; user applied loads; program generated loads; load distribution; load and location and reaction manipulation; structural product design; product selection; non-structural product selection; accessory design and selection; connector design and selection; total structure cost analysis; framing layout; CAD capabilities; external program connectivity; project status monitoring; product property files; home layout options; and construction industry data collection.

Although described in connection with an exemplary computing system environment, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, the client computers 12 and central server 16 execute computer-executable instructions such as those illustrated in FIGS. 3-5. As described above, the invention provides a single integrated software solution for the structural frame of a house. System 10 shares the input and critical data for all components of the structure. This is a significant improvement over currently available solutions that require multiple and duplicate input into separate programs to design the roof, walls and floors. Moreover, system 10 automatically transfers both horizontal and vertical loads to the structure.

An important role of the software product is the design, analysis, and integration of all the materials and components in the structural frame of a home from the foundation up. Material specification, design, and material optimization are preferably based on generic Industry and code-accepted methodologies for wood frame construction. Additionally, the software generates a complete and accurate material list, along with labor estimating routines, to help develop a complete costing model for the structure and all cladding materials.

It is to be understood by those skilled in the art that proprietary products of competitors may be incorporated within the software on a licensed basis through the program's generic capabilities or through proprietary modules developed by the competitors that are accessed through the program's open access transfer mechanism. Proprietary methodologies and optimization routines may also be incorporated and available through restrictive user licensing arrangements through program partners.

Functionally, the software of the present invention is designed around the concept that the portions of the critical input or design and analysis limits may come from each of the constituents in the building process. Alternatively, the software can be operated on a “master user” basis where a single user controls all input and options. The system 10 preferably provides design and analysis of roofs, walls, floor, exterior decks, and any other structural members above the foundation. The software develops both structure and component level loads from gravity, wind, and seismic loads as defined in the International Building Code for all members and components of the structural frame. The software then distributes all externally generated (user input) and all internally (program generated) generated structure loads. The ability to selectively combine both “prescriptive” and “designed” member capabilities permits a structural solution to be generated. Moreover, having the capability to handle member, component, and connector design using both “prescriptive” (e.g., wood frame construction manual) and “analyzed” (e.g., TPI or National Design Specification standards) designs enhances system 10. The software of the present invention further develops a complete material list, including accessories, for the entire building envelope (includes interior structural elements).

It is to be understood that there are a number of ways to execute this application other than the component-based architecture disclosed herein. For example, all of the code may be included in a single executable file. Although a single executable file would likely insure decent performance, real-time distributed capabilities, encapsulation, and real-time extensibility, and the like will not be available. Yet another embodiment of the invention employs standard client/server design in which a light, or thin, client is used with other components bundled into a single server executable. This embodiment, however, still does not provide the benefits of a distributed component architecture.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computerized method for modeling a structural frame of a building, said building frame having a plurality of members, said method comprising:
identifying one or more of said members bearing at least a portion of a total load to be supported by the building frame;
identifying connections between the load bearing members of the building frame;
assigning load values to the load bearing members of the building frame based on the identified connections; and
generating a building frame model based on the load values assigned to the load bearing members of the building frame to optimize construction of an actual building frame according to the model.

2. The method of claim 1 wherein assigning the load values includes estimating vertical or horizontal or both vertical and horizontal loads on the load bearing members.

3. The method of claim 1 further comprising defining a loading sequence by which the load values are assigned to the load bearing members of the building frame.

4. The method of claim 3 wherein the loading sequence is based on the identified connections to distribute the total load supported by the building frame among the load bearing members.

5. The method of claim 3 wherein the load value assigned to a subsequent one of the load bearing members in the loading sequence is a function of the load value assigned to an earlier one of the load bearing members in the loading sequence, said earlier and subsequent load bearing members in the sequence being connected to each other.

6. The method of claim 3 further comprising identifying which of the members are primary members and which of the members are secondary members, said primary members each being connected to and supporting at least one other member, and wherein the loading sequence is based on a set of hierarchical loading rules to distribute the total load supported by the building frame among at least the primary members.

7. The method of claim 6 wherein the primary members are one or more of the following: girders, beams, and headers.

8. The method of claim 1 wherein the members of the building frame are one or more of the following: trusses, studs, siding, openings, decks, beams, joists, rafters, drywall, and sheathing.

9. The method of claim 1 wherein the members of the building frame include structural components of at least one floor, a plurality of walls, and a roof.

10. The method of claim 1 wherein the load values are assigned to the load bearing members level-by-level for a multi-level building frame.

11. The method of claim 1 wherein the building frame is for a multi-level building and wherein assigning the load values includes transferring a vertical load from a higher level of the building frame to a next lower level of the building frame.

12. The method of claim 11 wherein transferring the vertical load includes assigning the load values to the load bearing members in the next lower level as a function of the load values assigned to one or more of the load bearing members connected thereto in the higher level of the building frame.

13. The method of claim 1 wherein each load value is representative of a load selected from one or more of the following: area load, concentrated load, and distributed load.

14. The method of claim 1 wherein generating the building frame model includes modeling the load applied to each of the load bearing members in local coordinates to reflect direct relationships between the load and the respective load bearing member.

15. The method of claim 1 wherein the load values are representative of one or more of the following: load magnitude, load location, and reaction on the respective load bearing member.

16. The method of claim 1 further comprising:
receiving a one or more input parameters from a plurality of users, said input parameters being representative of design characteristics of the building frame, said input parameters being received by a central server via one or more client computers operated by the users, said central server and client computers being coupled to a data communication network; and
communicating the building frame model to one or more of the users via the client computers coupled to the data communication network.

17. The method of claim 16 further comprising defining a hierarchy among the users to resolve conflicts between two or more of the input parameters and consolidating the input parameters by the central server according to the defined hierarchy, and wherein said building frame model is based on the consolidated input parameters.

18. The method of claim 16 further comprising deploying a plurality of software modules to the one or more client computers to assist the users in providing the input parameters to the central server.

19. The method of claim 18 wherein the software modules include a design modeling input module responsive to one or more of the input parameters for defining basic structural elements of the building frame.

20. The method of claim 18 wherein the software modules include an engineer preferences input module responsive to one or more of the input parameters for establishing load values for one or more load bearing members of the building frame.

21. The method of claim 20 wherein the engineer module further specifies structural performance requirements of the building frame.

22. The method of claim 18 wherein the software modules include a framer preferences input module responsive to one or more of the input parameters for specifying framing system parameters.

23. The method of claim 18 wherein the software modules include a builder information input module responsive to one or more of the input parameters for specifying product and performance requirements.

24. The method of claim 18 wherein one of the software modules comprises a master input module for consolidating information from other software modules into a unified job input, said unified job input representing a single master set of input parameters.

25. The method of claim 16 wherein each of the users is one or more of the following: a building designer, an engineer, a framer, and a builder.

26. The method of claim 1 wherein generating the building frame model includes generating a materials list and estimating costs associated with constructing the actual building frame according to the model.

27. The method of claim 1 wherein one or more computer-readable media have computer-executable instructions for performing the method of claim 1.

28. A computerized method for modeling a structural frame of a building based on collaborative input from one or more users, said method comprising:
receiving a plurality of input parameters from the users, said input parameters being representative of design characteristics of the building frame, said input parameters being received by a central server via one or more client computers operated by the users, said central server and client computers being coupled to a data communication network;
defining a hierarchy among the users to resolve conflicts between two or more of the input parameters;
consolidating the input parameters by the central server according to the defined hierarchy;
generating a building frame model based on the consolidated input parameters to optimize construction of an actual building frame according to the model; and
communicating the building frame model to one or more of the users via the client computers coupled to the data communication network.

29. The method of claim 28 wherein the central server is a web server and the data communication network is the Internet.

30. The method of claim 28 wherein each of the users is one or more of the following: a building designer, an engineer, a framer, and a builder.

31. The method of claim 28 wherein each of the client computers operates a browser-type input configured to permit the respective user to communicate on the data communication network and to specify one or more of the input parameters.

32. The method of claim 28 wherein generating the building frame model includes generating a materials list and estimating costs associated with constructing the actual building frame according to the model.

33. The method of claim 28 further comprising deploying a plurality of software modules to the one or more client computers to assist the users in providing the input parameters to the central server.

34. The method of claim 33 wherein the software modules include a design modeling input module responsive to one or more of the input parameters for defining basic structural elements of the building frame.

35. The method of claim 33 wherein the software modules include an engineer preferences input module responsive to one or more of the input parameters for establishing load values for one or more load bearing members of the building frame.

36. The method of claim 35 wherein the engineer module further specifies structural performance requirements of the building frame.

37. The method of claim 33 wherein the software modules include a framer preferences input module responsive to one or more of the input parameters for specifying framing system parameters.

38. The method of claim 33 wherein the software modules include a builder information input module responsive to one or more of the input parameters for specifying product and performance requirements.

39. The method of claim 33 wherein one of the software modules comprises a master input module for consolidating information from other software modules into a unified job input, said unified job input representing a single master set of input parameters.

40. The method of claim 28 wherein the input parameters include vertical and/or horizontal loads on load bearing members of the building frame.

41. The method of claim 28 further comprising defining default input parameters to automatically assign load values to one or more load bearing members of the building frame.

42. The method of claim 28 further comprising manipulating load magnitude, load location, and support reaction of one or more load bearing members of the building frame in response to the input parameters provided by at least one of the users.

43. The method of claim 28 wherein the building frame has a plurality of members, and further comprising:
identifying one or more of said members bearing at least a portion of a total load to be supported by the building frame;
identifying connections between the load bearing members of the building frame; and
assigning load values to the load bearing members of the building frame based on the identified connections, said building frame model being based on the load values assigned to the load bearing members of the building frame.

44. The method of claim 43 wherein assigning the load values includes estimating vertical or horizontal or both vertical and horizontal loads on the load bearing members.

45. The method of claim 43 further comprising defining a loading sequence by which the load values are assigned to the load bearing members of the building frame.

46. The method of claim 45 wherein the loading sequence is based on the identified connections to distribute the total load supported by the building frame among the load bearing members.

47. The method of claim 45 wherein the load value assigned to a subsequent one of the load bearing members in the loading sequence is a function of the load value assigned to an earlier one of the load bearing members in the loading sequence, said earlier and subsequent load bearing members in the sequence being connected to each other.

48. The method of claim 45 further comprising identifying which of the members are primary members and which of the members are secondary members, said primary members each being connected to and supporting at least one other member, and wherein the loading sequence is based on a set of hierarchical loading rules to distribute the total load supported by the building frame among at least the primary members.

49. The method of claim 43 wherein the load values are assigned to the load bearing members level-by-level for a multi-level building frame.

50. The method of claim 49 further comprising assigning the load values to the load bearing members in a next lower level of the multi-level building frame as a function of the load values assigned to one or more of the load bearing members connected thereto in a higher level of the multi-level building frame to transfer a vertical load from the higher level to the next lower level.

51. The method of claim 43 wherein generating the building frame model includes modeling the load applied to each of the load bearing members in local coordinates to reflect direct relationships between the load and the respective load bearing member.

52. The method of claim 28 wherein one or more computer-readable media have computer-executable instructions for performing the method of claim 28.

53. A computer-readable medium having computer-executable subsystem components comprising:
a client view subsystem for data input and visualization regarding a structural building frame;
a material management subsystem for managing building material inventory and design preferences of the building frame;
an entity component subsystem for managing activation of one or more components, said components including software modules responsive to one or more input parameters representative of design characteristics of the building frame;
an engineering subsystem for managing structural analysis and design of the building frame;
a database subsystem for saving and retrieving job data relating to construction of an actual building frame; and
a services subsystem for managing data flow among the other subsystems.

54. A system for modeling a structural frame of a building based on collaborative input from one or more users, said system comprising:
one or more client computers coupled to a data communications network;
a central server also coupled to the data communication network, said central server receiving a plurality of input parameters from the users via one or more of the client computers, said input parameters being representative of design characteristics of the building frame, said central server consolidating the input parameters according to a defined hierarchy among the users to resolve conflicts between two or more of the input parameters; and
a database associated with the central server for storing job information, said central server generating a building frame model based on the consolidated input parameters and the stored job information to optimize construction of an actual building frame according to the model.

55. The system of claim 54 wherein the central server is a web server and the data communication network is the Internet.

56. The system of claim 54 wherein each of the users is one or more of the following: a building designer, an engineer, a framer, and a builder.

57. The system of claim 54 further comprising a browser operated by each of the client computers, said browser being configured to permit the respective user to communicate on the data communication network and to specify one or more of the input parameters.

58. The system of claim 54 wherein the building frame model includes a materials list and a cost estimate associated with constructing the actual building frame according to the model.

59. The system of claim 54 further comprising a plurality of software modules deployed to the one or more of the client computers to assist the users in providing the input parameters to the central server.

60. The system of claim 59 wherein the software modules include a design modeling input module responsive to one or more of the input parameters for defining basic structural elements of the building frame.

61. The system of claim 59 wherein the software modules include an engineer preferences input module responsive to one or more of the input parameters for establishing load values for one or more load bearing members of the building frame.

62. The system of claim 61 wherein the engineer module further specifies structural performance requirements of the building frame.

63. The system of claim 59 wherein the software modules include a framer preferences input module responsive to one or more of the input parameters for specifying framing system parameters.

64. The system of claim 59 wherein the software modules include a builder information input module responsive to one or more of the input parameters for specifying product and performance requirements.

65. The system of claim 59 wherein one of the software modules comprises a master input module for consolidating information from other software modules into a unified job input, said unified job input representing a single master set of input parameters.

66. The system of claim 54 wherein the input parameters include vertical and/or horizontal loads on load bearing members of the building frame.

67. The system of claim 54 wherein the building frame has a plurality of connected members, one or more of said members bearing at least a portion of a total load to be supported by the building frame, said load bearing members of the building frame having load values assigned thereto based on the connections, said building frame model being based on the load values assigned to the load bearing members of the building frame.

68. The system of claim 67 wherein the load value assigned to a subsequent one of the load bearing members in a loading sequence is a function of the load value assigned to an earlier one of the load bearing members in the loading sequence, said earlier and subsequent load bearing members in the sequence being connected to each other.

69. The system of claim 68 wherein the building members include primary members and secondary members, said primary members each being connected to and supporting at least one other member, and wherein the loading sequence is based on a set of hierarchical loading rules to distribute the total load supported by the building frame among at least the primary members.

70. The system of claim 67 wherein the load values are assigned to the load bearing members level-by-level for a multi-level building frame.

71. The system of claim 70 wherein the load values are assigned to the load bearing members in a next lower level of the multi-level building frame as a function of the load values assigned to one or more of the load bearing members connected thereto in a higher level of the multi-level building frame to transfer a vertical load from the higher level to the next lower level.
